(19) United States
(12) Patent Application Publication
(10) Pub. No.: US 2011/0109471 A1
(43) Pub. Date: May 12, 2011

(54) SENSOR NODE AND METHOD FOR SAMPLING PREAMBLE, AND APPARATUS AND METHOD FOR COMPUTING PREAMBLE INTERVAL

(75) Inventors: Noseong Park, Daejeon (KR); Yoonmee Doh, Daejeon (KR); Jong-Arm Jun, Daejeon (KR)

(73) Assignee: ELECTRONICS AND TELECOMMUNICATIONS RESEARCH INSTITUTE, Daejeon (KR)

(21) Appl. No.: 12/785,010

(22) Filed: May 21, 2010

(30) Foreign Application Priority Data
Nov. 12, 2009 (KR) 10-2009-0109025

(51) Int. Cl. G08C 19/16

(52) U.S. Cl. 340/870.01

(57) ABSTRACT

Provided are a sensor node and method for a preamble sampling, and an apparatus and method for computing a preamble interval. A transceiver may verify a number of neighboring nodes positioned in a sensor network, and a sampling unit may perform the preamble sampling using a sampling duration that is set based on the number of neighboring nodes.

### CROSS-REFERENCE TO RELATED APPLICATION

This application claims the benefit of Korean Patent Application No. 10-2009-0109025, filed on Nov. 12, 2009, in the Korean Intellectual Property Office, the disclosure of which is incorporated herein by reference.

### BACKGROUND

1. Field of the Invention

The present invention relates to a sensor node and method for a preamble sampling, and an apparatus and method for computing a preamble interval. More particularly, the present invention relates to a sensor node and method for a preamble sampling that may determine a sampling duration based on a neighboring environment including a neighboring node, and an apparatus and method for computing a preamble interval.

2. Description of the Related Art

A transmission node constituting a sensor network generally performs a functionality of a battery. Accordingly, to enhance a lifespan of the sensor network, a battery consumption amount may need to decrease by reducing a duty cycle. One of schemes employed to reduce the duty cycle may use an asynchronous Media Access Control (MAC) protocol using a preamble sampling.

However, when the asynchronous MAC protocol is used, an interval where a transmission node transmits a preamble may not be constant due to a random backoff. In this case, a reception node may redundantly set a preamble sampling duration to not miss a preamble. Due to the redundant sampling duration, the reception node may consume a relatively large amount of power, which may result in reducing a battery lifespan.

### SUMMARY

An aspect of the present invention provides a sensor node and method for a preamble sampling, and an apparatus and method for computing a preamble interval that may reduce a preamble sampling duration while not damaging a reliability, and may also set a sampling duration to enhance a battery lifespan.

According to an aspect of the present invention, there is provided a sensor node for a preamble sampling, including: a transceiver to verify a number of neighboring nodes positioned in a sensor network; and a sampling unit to perform the preamble sampling using a sampling duration that is set based on the number of neighboring nodes.

The sensor node may further include a storage unit to store the sampling duration mapped with the number of neighboring nodes. The sampling unit may verify, from the storage unit, the sampling duration mapped with the number of neighboring nodes to perform the preamble sampling.

The sampling unit may adjust the sampling duration based on traffic at the sensor network and a transmission success rate of a preamble.

When a state of the sensor network is less than a reference value, the sampling unit may extend the set sampling duration.

According to another aspect of the present invention, there is provided an apparatus of computing a preamble interval, including: a first computation unit to compute a probability that a transmission node fails in a channel obtainment, an average time used until the transmission node fails in the channel obtainment and thereby a preamble transmission is cancelled, and an average time used until the transmission node succeeds in the channel obtainment and thereby the preamble transmission succeeds; and a second computation unit to compute an expectation value of the preamble interval based on the computed two average times and a success probability of the channel obtainment according to a number of neighboring nodes.

The apparatus may further include: a third computation unit to compute a failure probability of a Clear Channel Assessment (CCA) based on the computed expectation value of the preamble interval, the number of neighboring nodes, and a length of a preamble signal; and a controller to set the computed expectation value of the preamble interval as a sampling duration when the computed failure probability converges to a particular value.

The failure probability of the CCA may be in proportion to the number of neighboring nodes.

The controller may control the first computation unit through the third computation unit to compute the expectation value of the preamble interval until the failure probability computed by the third computation unit converges to the particular value.

The expectation value of the preamble interval computed by the second computation unit may be in proportion to the number of neighboring nodes.

The controller may set, as a sampling duration of a reception node, a value greater than or equal to the computed expectation value of the preamble interval.

According to still another aspect of the present invention, there is provided a preamble sampling method of a sensor node, the method including: verifying a number of neighboring nodes positioned in a sensor network; and performing preamble sampling using a sampling duration that is set based on the number of neighboring nodes.

The method may further include storing the sampling duration mapped with the number of neighboring nodes. The performing of the preamble sampling may include verifying the sampling duration mapped with the number of neighboring nodes to perform the preamble sampling.

The performing of the preamble sampling may include adjusting the sampling duration based on traffic at the sensor network and a transmission success rate of a preamble.

The performing of the preamble sampling may include extending the set sampling duration when a state of the sensor network is less than a reference value.

According to yet another aspect of the present invention, there is provided a method of computing a preamble interval, including: computing an average time used until a transmission node fails in a channel obtainment and thereby a preamble transmission is cancelled, and an average time used until the transmission node succeeds in the channel obtainment and the preamble transmission succeeds, based on a probability that the transmission node fails in the channel obtainment; and computing an expectation value of the preamble interval based on the computed two average times and a success probability of the channel obtainment according to a number of neighboring nodes.

The method may further include: computing a failure probability of a CCA based on the computed expectation value of the preamble interval, the number of neighboring nodes, and a length of a preamble signal; and setting the computed expectation value of the preamble interval as the sampling duration when the computed failure probability converges to a particular value.

The failure probability of the CCA may be in proportion to the number of neighboring nodes.

The computed expectation value of the preamble interval may be in proportion to the number of neighboring nodes.

The setting may include setting, as a sampling duration of a reception node, a value greater than or equal to the computed expectation value of the preamble interval.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating transmission and reception nodes using an asynchronous low power Media Access Control (MAC) protocol according to an embodiment of the present invention;

FIG. 2 illustrates a sensor network to describe computation of a sampling duration according to an embodiment of the present invention;

FIG. 3 is a block diagram illustrating a first transmission node and a reception node according to an embodiment of the present invention;

FIG. 4 is a diagram illustrating a case where a signal detector fails in a channel obtainment for transmitting a preamble according to an embodiment of the present invention;

FIG. 5 is a diagram illustrating a case where a signal detector succeeds in a channel obtainment for transmitting a preamble according to an embodiment of the present invention;

FIG. 6 is a diagram illustrating a process of transmitting a preamble according to an embodiment of the present invention;

FIG. 7 is a block diagram illustrating a preamble interval computing apparatus to compute an expectation value of a preamble interval according to an embodiment of the present invention;

FIG. 8 is a flowchart illustrating a preamble sampling method of a sensor node according to an embodiment of the present invention; and

FIG. 9 is a flowchart illustrating a method of computing a preamble interval according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

When it is determined detailed description related to a related known function or configuration they may make the purpose of the present invention unnecessarily ambiguous in describing the present invention, the detailed description will be omitted here. Also, terms used herein are defined to appropriately describe the exemplary embodiments of the present invention and thus may be changed depending on a user, the intent of an operator, or a custom. Accordingly, the terms must be defined based on the following overall description of this specification.

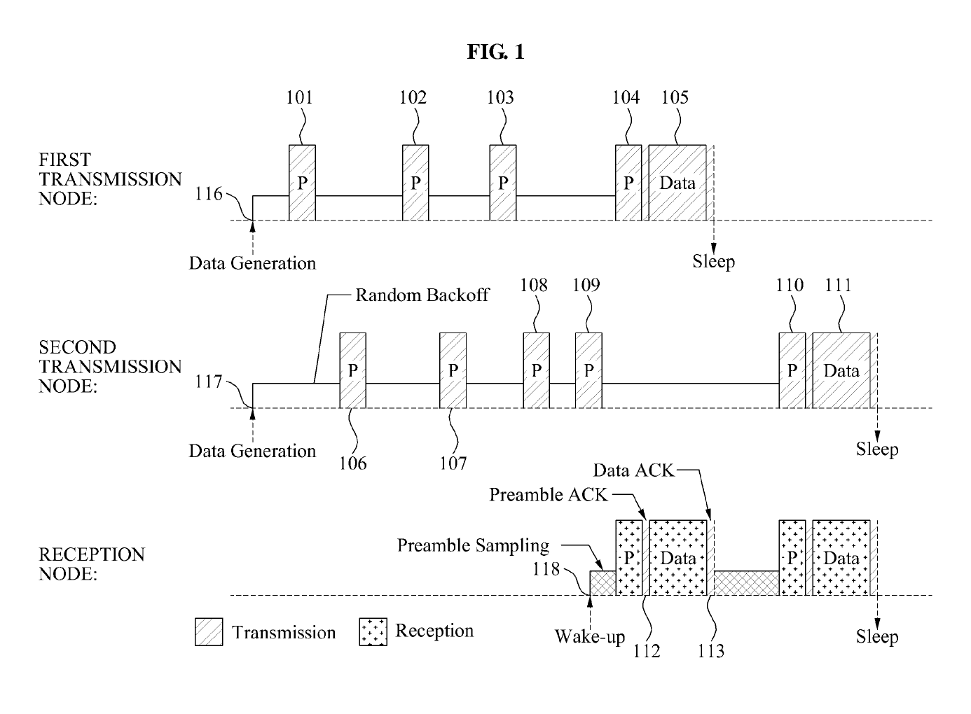

FIG. 1 is a diagram illustrating transmission and reception nodes using an asynchronous low power Media Access Control (MAC) protocol according to an embodiment of the present invention.

Referring to FIG. 1, a sensor network may include a first transmission node, a second transmission node, and a single reception node. The first transmission node and the second transmission node may transfer data 105 and 111 to the reception node using a Clear Channel Assessment (CCA) scheme.

When data to be transmitted to the reception node is generated at respective points in times 116 and 117, the first transmission node and the second transmission node may wake up to transmit a preamble to the reception node. According to a Carrier Sense Multiple Access/Collision Avoidance (CSMA/CA) rule, the first transmission node may transmit preambles 101, 102, 103, and 104, and the second transmission node may transmit preambles 106, 107, 108, 109, and 110.

The reception node may periodically performing sampling with respect to whether a preamble is received. Referring to FIG. 1, the reception node wakes up at a point in time 118 to receive the preamble 104 transmitted from the first transmission node, and to transmit a preamble acknowledgement (ACK) 112 to the first transmission node.

The first transmission node may receive the preamble node ACK 112 from the reception node to detect that the reception node is awaken, and may transmit the data 105 to the reception node. The reception node receiving the data 105 may transmit a data ACK 113 to the first transmission node. The second transmission node and the reception node may perform communication in the aforementioned manner. When the communication is completed, the reception node may enter a sleep mode.

As described above, in the sensor network, whenever a preamble is transmitted, CSMA/CA may be used. Accordingly, an interval between preambles (hereinafter, referred to as a “preamble interval”) may be variable due to a random backoff. A sampling duration may need to be the same as the preamble interval. However, since the preamble interval is variable, it may be appropriate to use an optimal sampling duration. The optimal sampling duration indicates a minimum sampling duration making it possible to reduce a battery consumption while maintaining a probability of missing a preamble.

The optimal sampling duration may be important due to the following reasons: When a number of neighboring nodes is large, contention may become serious and thus a preamble interval may become longer. Conversely, when the number of neighboring nodes is small, the preamble interval may become short. When the sampling duration is short in the reception node, a probability that the reception node may miss a preamble may increase. On the other hand, since the reception node samples preambles during only a short period of time, a power consumption may decrease. Accordingly, to decrease the power consumption, the optimal sampling duration may need to be short, however, may not be short to significantly decrease the probability that the reception node may miss a preamble. Specifically, the optimal sampling duration may need to be an appropriate value.

When the sampling duration is long, the reception node may stably receive preambles without missing the preambles. However, even when a preamble is not transmitted from the first transmission node or the second transmission node, the reception node may need to perform preamble sampling to determine whether the preamble is continuously received. Accordingly, a power consumption may increase.

According to an embodiment of the present invention, it is possible to compute the optimal sampling duration based on a neighboring environment. For example, the neighboring environment may include at least one of a number of neighboring nodes, a transmission success rate of a preamble, and a traffic amount.

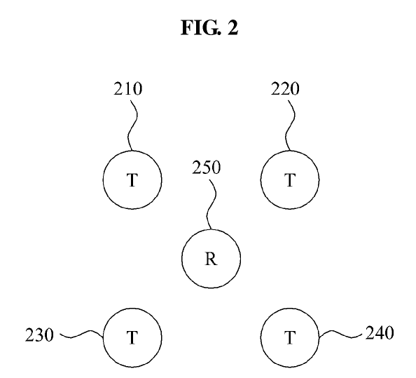

FIG. 2 illustrates a sensor network to describe computation of a sampling duration according to an embodiment of the present invention.

According to an embodiment of the present invention, when a preamble is transmitted using a CSMA/CA algorithm defined in an Institute of Electrical and Electronics Engineers (IEEE) 802.15.4 standard, it is possible to compute an expectation value of a preamble interval according to a mathematical analysis, and to set a sampling duration based on the computed expectation value of the preamble interval. The expectation value of the preamble interval may indicate a predicted value of the preamble interval that may be used in a predetermined transmission node when N neighboring nodes exist.

For the above mathematical analysis, as shown in FIG. 2, a sensor network where four transmission nodes 210, 220, 230, and 240 and a single reception node 250 are provided in a star form or a mesh form may be assumed. All of the transmission nodes 210, 220, 230, and 240, and the reception node 250 may communicate with each other using, for example, the CSMA/CA algorithm defined in the IEEE 802.15.4 standard. Also, all of the transmission nodes 210, 220, 230, and 240, and the reception node 250 may perform a functionality of a transmission side node or a reception side node with respect to each other.

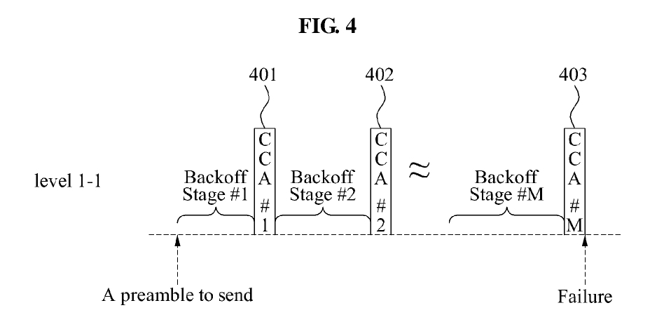

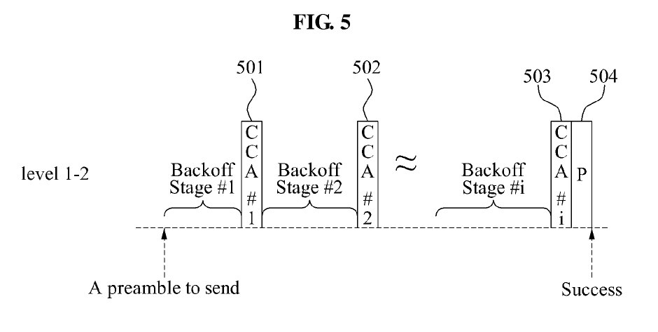

According to an embodiment of the present invention, one of the N transmission nodes may compute a preamble interval of a corresponding transmission node using a reproduction theory. According to the reproduction theory, a preamble transmission process of a predetermined transmission node may be classified into an operation of FIG. 4 and an operation of FIG. 5. Hereinafter, descriptions will be made based on an example of using the transmission node 210 as a first transmission node 210.

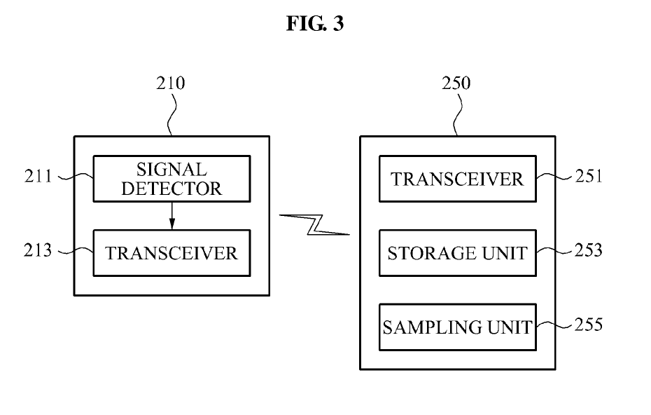

FIG. 3 is a block diagram illustrating a first transmission node 210 and a reception node 250 according to an embodiment of the present invention.

Referring to FIG. 3, the first transmission node 210 may include a signal detector 211 and a transceiver 213.

The signal detector 211 may detect whether another signal exists in a channel to transmit a preamble, using a CCA scheme. When the signal does not exist in the channel, the transceiver 213 may avoid a collision with the other signal by transmitting the preamble via the channel. The signal detector 211 may continuously attempt a CCA set maximum times M of CCA. A case where a channel attempt fails even after attempting the CCA the maximum times M may correspond to level 1-1. A case where the channel obtainment succeeds prior to the maximum times M may correspond to level 1-2. It will be described later.

FIG. 4 is a diagram illustrating a case where the signal detector 211 fails in a channel obtainment for transmitting a preamble according to an embodiment of the present invention, and FIG. 5 is a diagram illustrating a case where the signal detector 211 succeeds in a channel obtainment for transmitting a preamble according to an embodiment of the present invention.

Referring to FIG. 4, level 1-1 shows a case where the signal detector 211 attempted the CCA the predetermined maximum times M, however, failed M times in a row and thereby a preamble transmission fails. CCA #M denotes a number of times that the CCA was performed, Backoff Stage denotes a time or a size of a random backoff window, and Backoff Stage #M denotes a number of times that backoff occurred. The signal detector 211 detected a signal in all the CCA processes 401, 402, and 403, however, failed in the channel obtainment. When a default value of the maximum times M is set to “5”, the signal detector 211 may attempt the CCA five times. When the signal detector 211 fails in the channel obtainment with respect to the attempted five CCAs, the signal detector 211 may attempt the CCA again after a random backoff period.

Referring to FIG. 5, level 1-2 shows a case where the signal detector 211 succeeds in the channel obtainment to thereby transmit a preamble. The signal detector 211 failed in the channel obtainment in CCA processes 501 and 502, however, succeeded in the channel obtainment in an i^{th} CCA process 503 to thereby obtain a channel. Accordingly, the transceiver 213 may transmit a preamble 504 to the reception node 250 via the obtained channel.

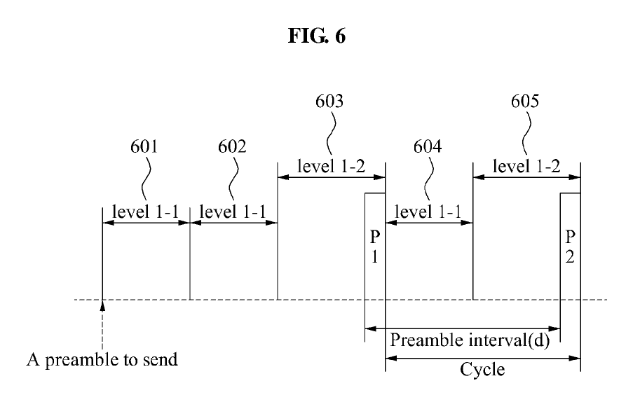

FIG. 6 is a diagram illustrating a process of transmitting a preamble according to an embodiment of the present invention.

A preamble may be transmitted through at least one level 1-1 process and a last one level 1-2 process. Also, the preamble may be transmitted through one level 1-2 process without the level 1-1 process.

Referring to FIG. 6, preamble P1 is transmitted through two level 1-1 processes 601 and 602, and one level 1-2 process 603, and preamble P2 is transmitted through one level 1-1 process 604 and one level 1-2 process 605. An interval from a point in time when P1 is transmitted to a point in time when P2 is transmitted corresponds to a preamble interval d, that is, indicates a cycle of level 2. According to a reproduction theory, the cycle denotes an interval between points in times when a sensor node is stochastically reproduced. In a preamble transmission process, an operation of the sensor node depends on a success probability or a failure probability of CCA. Specifically, after transmitting the preamble P1, the sensor node may be stochastically reproduced to transmit the preamble P2. An interval or a cycle between preambles may be different every time, however, may be the same process depending on only the CCA success/failure probability. Therefore, once a preamble is transmitted, the interval or the cycle may be reproduced to predict when a subsequent preamble is transmitted, as a probability model.

As described above, the first transmission node 210 may obtain a channel using a CCA process, and may transmit a preamble via the obtained channel. In this instance, the preamble transmission interval may not be constant due to random backoff.

Therefore, according to an embodiment of the present invention, the reception node 250 may perform preamble sampling using an optimal sampling duration that is computed based on a neighboring environment. Specifically, the reception node 250 may set a sampling duration corresponding to a predicted preamble interval, and attempt sampling at every set sampling duration. For this, the reception node 250 may store the sampling duration that is computed based on the neighboring environment.

Referring again to FIG. 3, the reception node 250 may include a transceiver 251, a storage unit 253, and a sampling unit 255. The reception node 250 may be positioned in the sensor network to perform a functionality of a transmission node transmitting a preamble to another transmission node, for example, the transmission node 202 of FIG. 2.

The transceiver 251 may communicate with neighboring nodes positioned in the sensor network to verify a number N of neighboring nodes. In FIG. 2, the number N of neighboring nodes may be verified as “4”. Also, the transceiver 251 may receive a preamble transmitted from the at least one of the neighboring nodes.

The storage unit 253 may store a sampling duration mapped with the number N of neighboring nodes. Here, N=1, 2, . . . , n, and n denotes a constant. For example, the sampling duration may be stored in the storage unit 253 in a form of a lookup table as shown in Table 1 below. The sampling duration may be greater than or equal to the computed expectation value of the preamble interval.

TABLE 1

| Number of neighboring nodes (N) | Sampling duration |
|---|---|
| 2 | 2 ms |
| 3 | 3 ms |
| . . . | . . . |

The sampling unit 255 may perform preamble sampling using the sampling duration that is set based on the verified number N of neighboring nodes. The sampling unit 255 may verify, from the storage unit 253, a sampling duration mapped with the verified number N of neighboring nodes, and perform preamble sampling based on the verified sampling duration. When a sampling period is set, the sampling unit 255 may attempt or perform the preamble sampling during the verified sampling duration within the set sampling period.

The sampling unit 255 may adjust the sampling duration verified in the storage unit 253, based on traffic of the sensor network and a transmission success rate of a preamble. For example, when a state of the sensor network is less than a predetermined reference value, the sampling unit 255 may extend the verified sampling duration. The traffic and the transmission success rate of the preamble may be known from communication results between the transceiver 251 and the nodes, for example, the transmission nodes 210, 220, 230, 240, and the reception node 250 of the sensor network, which corresponds to a known art and thus further descriptions related thereto will be omitted here.

Hereinafter, a process of computing an expectation value of a preamble interval will be described according to an embodiment of the present invention.

A manager may compute the expectation value of the preamble interval, that is, an optimal preamble interval using a computing apparatus such as a computer by referring to the transmission process of FIG. 6. As shown in FIG. 6, a single cycle may be a geometrical distribution including the level 1-1 process and the level 1-2 process. Accordingly, the expectation value of the preamble interval may be the same as an average cycle length, that is, a time in level 2, which may be expressed by Equation 1.

$$E [ {T}_{cycle} ] = ( \frac{1}{p} - 1 ) \cdot E [ {T}_{level 1 \text{-} 1} ] + E [ {T}_{level 1 \text{-} 2} ] \qquad [ Equation 1 ]$$

In Equation 1, p denotes a probability of level 1-2, that is, a probability that a channel obtainment may succeed to thereby transmit a preamble. Accordingly, 1−p may be a probability of level 1-1, that is, a probability that the channel obtainment may fail.

Also, E[T_{cycle}] denotes the expectation value of the preamble interval, that is, a predicted preamble interval, E[T_{level 1-1}] denotes an average time of level 1-1 where a CCA process continuously fails and thereby a preamble transmission is cancelled, and E[T_{level 1-2}] denotes an average time of level 1-2 where the CCA process succeeds and thereby the preamble transmission succeeds. The expectation value of the preamble interval computed according to Equation 1 may be stored in the reception node 250. The reception node 250 may determine the sampling duration based on the stored expectation value of the preamble interval.

As described above, the probability (1−p) of level 1-1 denotes a probability that the CCA process may continuously fail set maximum times M. Accordingly, when the failure probability of the CCA process is α, the probability (1−p) of level 1-1 may be α^{M}. Since a probability p of level 1-2 is 1−α^{M}, p may be 1−α^{M}. As shown in Equation 3, α may be affected by the number N of neighboring nodes and thus the expectation value of the preamble interval according to Equation 1 may be computed based on a neighboring environment.

According to an IEEE 802.15.4 standard, E[T_{level 1-1}] and E[T_{level 1-2}] may be computed according to Equation 2.

$$E [ {T}_{level 1 \text{-} 1} ] = {\sum }_{i = 1}^{M} ( \frac{{W}_{i}}{2} + {T}_{CCA} ) \\ E [ {T}_{level 1 \text{-} 2} ] = {\sum }_{i = 1}^{M} ( {\sum }_{j = 1}^{i} ( \frac{{W}_{j}}{2} + {T}_{CCA} ) \cdot {α}^{i - 1} \cdot ( 1 - α ) ) \qquad [ Equation 2 ]$$

In Equation 2, E[T_{level 1-1}] denotes the average time of level 1-1 where the CCA process continuously fails and thereby the preamble transmission is cancelled, and E[T_{level 1-2}] denotes the average time of level 1-2 where the CCA process succeeds and thereby the preamble transmission succeeds. Also, M denotes a maximum value to attempt the CCA, Wᵢ denotes a maximum value of a random backoff window in each backoff stage #n, and T_{CCA} denotes an amount of time used to perform the CCA once. When an embodiment of the present invention follows the IEEE 802.15.4 standard, T_{CCA} may be 128 μs.

The failure probability α of the CCA s may be determined depending on a number of preamble signals existing in a channel. Generally, a number of preambles may increase according to an increase in a number of nodes in the sensor network and thus the failure probability a may also increase. It may be expressed by Equation 3.

$$α = \frac{N \cdot {T}_{preamble}}{E [ {T}_{cycle} ]} \qquad [ Equation 3 ]$$

In Equation 3, T_{preamble} denotes a value obtained by changing a length of a preamble signal to a time, and N denotes the number of neighboring transmission nodes. All the nodes existing in the sensor network may transmit a preamble once in 2 cycle of FIG. 6, and thus a signal corresponding to an amount of time N·T_{preamble} may exist in one channel during one cycle. In the case that a point in time when the CCA is performed overlaps a time when the signal exists, the CCA may fail. Accordingly, the failure probability α of the CCA may be expressed by Equation 3.

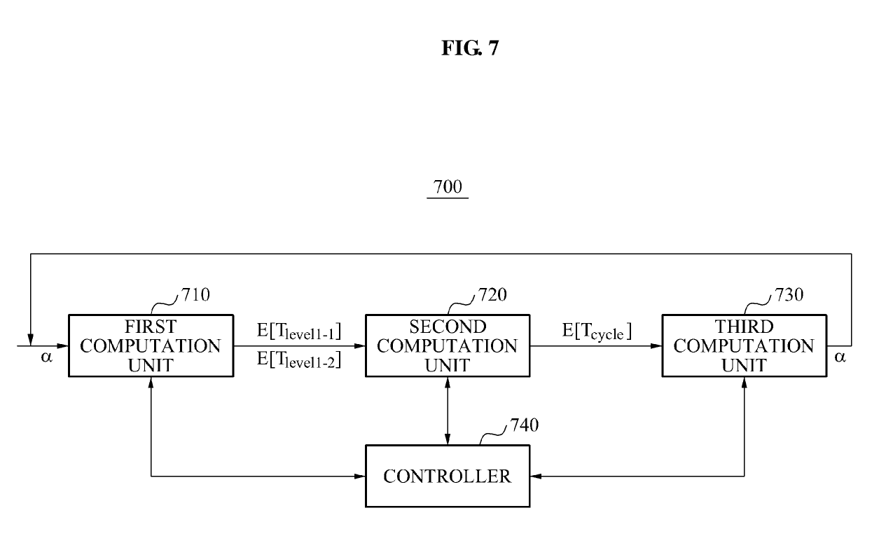

FIG. 7 is a block diagram illustrating a preamble interval computing apparatus 700 to compute an expectation value of a preamble interval according to an embodiment of the present invention.

Referring to FIG. 7, the preamble interval computing apparatus 700 may include a first computation unit 710, a second computation unit 720, a third computation unit 730, and a controller 740.

The first computation unit 710 may compute a probability that a transmission node may fail in a channel obtainment, an average time used until the transmission node fails in the channel obtainment and thereby a preamble transmission is cancelled, and an average time used until the transmission node succeeds in the channel obtainment and thereby the preamble transmission succeeds.

Specifically, the first computation unit 710 may compute the average time E[T_{level 1-1}] used until the transmission node fails in the channel obtainment and thereby a preamble transmission is cancelled and the average time E[T_{level 1-2}] used until the transmission node succeeds in the channel obtainment and the preamble transmission succeeds, using an initial value of α. That is, E[T_{level 1-1}] may be the average time used until the CCA process continuously fails and thereby the preamble transmission is cancelled, and E[T_{level 1-2}] may be the average time used until the CCA process succeeds and thereby the preamble transmission succeeds.

The first computation unit 710 may compute the two average times according to Equation 2. In Equation 2, the initial value of α may be arbitrarily input by a user or be randomly set by the preamble interval computing apparatus 700. M denotes the maximum number of times that each transmission node may continuously perform the CCA process, and thus may be set to be variable for each sensor network.

The second computation unit 720 may compute an expectation value E[_{cycle}] of the preamble interval based on the computed two average times and a probability p that the channel obtainment succeeds to thereby transmit a preamble. Equation 1 may use p=1−α^{M}. As shown in Equation 3, α may be affected by the number N of neighboring nodes and thus the expectation value of the preamble interval may be computed based on the number N of neighboring nodes. The expectation value of the preamble interval computed by the second computation unit 720 may be in proportion to the number N of neighboring nodes.

A third computation unit 730 may compute a failure probability α of a CCA based on the computed expectation value E[T_{cycle}] of the preamble inerval, the number N of neighboring nodes, and a length Tpreamble of a preamble signal. The third computation unit 730 may compute the failure probability α of the CCA according to Equation 3. The failure probability α of the CCA may be in proportion to the number N of neighboring nodes.

When the computed failure probability α converges to a particular value, the controller 740 may set the computed expectation value of the preamble interval as a sampling duration. Also, the controller 740 may control the first computation unit 710 through the third computation unit 730 to compute the expectation value of the preamble interval until the failure probability α computed by the third computation unit 730 converges to the particular value. The particular value may be determined according to a reproduction theory.

Also, the controller 740 may set, as a sampling duration of a reception node, a value greater than or equal to the computed expectation value of the preamble interval, and may provide the set sampling duration to the reception node.

As shown in FIG. 7, Equation 1 through Equation 3 may configure a closed-loop form. Accordingly, as shown in FIG. 7, the controller 740 may control a circulation iteration of computing α to continue by substituting the initial value of α for Equation 2, by substituting a result of Equation 2 for Equation 1, and by substituting a result of Equation 1 for Equation 3. When α computed by Equation 3 converges to the particular value and does not change any more, the controller 740 may suspend the circulation iteration and may determine E[T_{cycle}] at that moment as the expectation value of the preamble interval.

The expectation value of the preamble interval computed through the aforementioned process may be set as the sampling duration of each node. Accordingly, a node performing a functionality of a reception node may store the computed expectation value of the preamble interval and may perform preamble sampling by using the above interval as a period.

The preamble interval computing apparatus 700 may change the number of neighboring nodes and compute the expectation value of the preamble interval corresponding to the changed number of neighboring nodes. The expectation value of the preamble interval mapped with the computed number of neighboring nodes may be stored in each node in a form of a lookup table. When each node performs a functionality of a reception node, each node may verify the number of neighboring nodes and set, as a sampling duration, the expectation value mapped with the verified number of neighboring nodes to thereby perform preamble sampling.

The preamble interval computing apparatus 700 may be provided as a separate device such as a computer, or may be installed in each node.

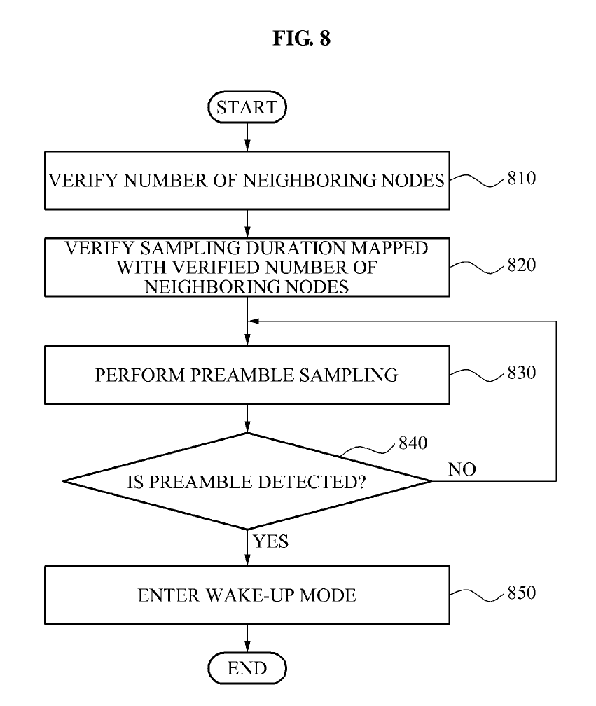

FIG. 8 is a flowchart illustrating a preamble sampling method of a sensor node according to an embodiment of the present invention.

Descriptions will be made using the reception node 250 of FIG. 2 as the sensor node.

In operation 810, the transceiver 251 may communicate with neighboring nodes positioned in a sensor network to verify a number of the neighboring nodes.

In operations 820 and 830, the sampling unit 255 may perform preamble sampling using a sampling duration that is set based on the verified number of neighboring nodes. In particular, the sampling unit 255 may verify, from the storage unit 253, a sampling duration mapped with the verified number of neighboring nodes, and may perform preamble sampling based on the verified sampling duration.

When the sampling unit 255 detects a preamble by performing the preamble sampling in operation 840, the reception node 250 may enter a wake-up mode in operation 850. The reception node 250 may perform a general routine process for data reception. For example, the reception node 250 may transmit a preamble ACK to a transmission node and receive data from the transmission node.

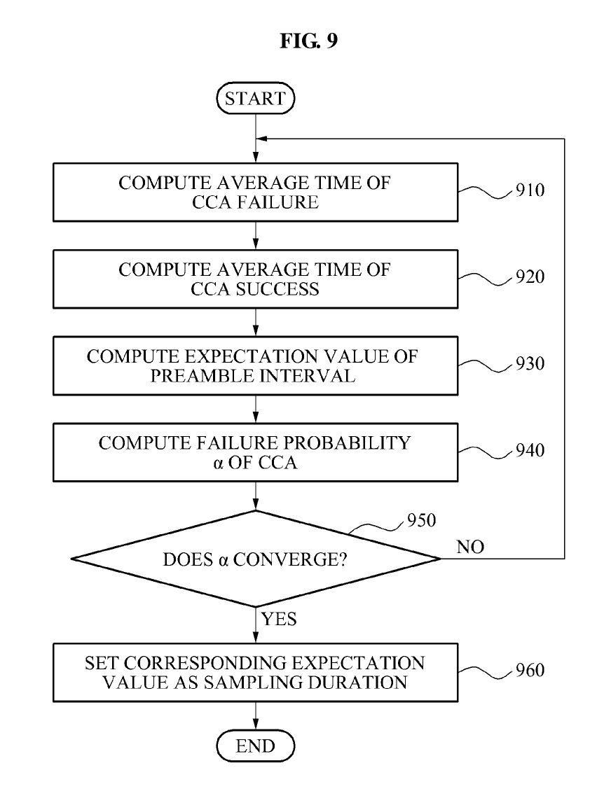

FIG. 9 is a flowchart illustrating a method of computing a preamble interval according to an embodiment of the present invention. The preamble interval computing method may be performed by the preamble interval computing apparatus of FIG. 7.

Referring to FIG. 9, in operation 910, the first computation unit 710 may compute an average time E[T_{level 1-1}] used until a preamble transmission is cancelled, based on a failure probability α that a transmission node fails in a channel obtainment. E[T_{level 1-1}] may be the average time used until a CCA process continuously fails and thereby the preamble transmission is cancelled.

In operation 920, the first computation unit 710 may compute an average time E[T_{level 1-2}] used until the transmission node succeeds, based on the failure probability α that the transmission node fails in the channel obtainment. E[T_{level 1-2}] may be the average time used until the CCA process succeeds and thereby the preamble transmission succeeds. In operations 910 and 920, the first computation unit 710 may use Equation 2.

In operation 930, the second computation unit 720 may compute an expectation value E[T_{cycle}] of the preamble interval based on the computed two average times E[T_{level 1-1}] and E[T_{level 1-2}] and a probability p that the channel obtainment succeeds to thereby transmit a preamble. In operation 930, the second computation unit 720 may use Equation 1.

In operation 940, the third computation unit 730 may compute a failure probability α of CCA based on the computed expectation value E[T_{cycle}] of the preamble interval, the number N of neighboring nodes, and a length Tpreamble of a preamble signal. In operation 940, the third computation unit 730 may use Equation 3.

When the computed failure probability α converges to a particular value in operation 950, the controller 740 may set the computed expectation value of the preamble interval as a sampling duration in operation 960.

Conversely, when the computed failure probability α does not converge to the particular value in operation 950, the controller 740 may repeat operations 910 through 940 until the computed failure probability α converges to the particular value.

The aforementioned embodiment of the present invention may employ a scheme of computing a sampling time to be suitable for a number of neighboring nodes in an asynchronous low power MAC of a preamble sampling scheme. It may be used for a low power router (LPR) of a ZigBee Pro standard, a low power MAC protocol of a TinyOS, an IEEE 802.15.4e standard, and the like.

Also, the sensor network of FIG. 2 may be adaptively used for a ubiquitous environment and thus effectively operate nodes while reducing a power of each sensor node.

According to an embodiment of the present invention, it is possible to reduce a preamble sampling time while not damaging a reliability. In particular, it is possible to reduce a probability that a reception node may miss a preamble, and a power consumption of the reception node by computing a sampling duration to be used in the sensor network based on a neighboring environment such as a number of neighboring nodes. This is because sampling is attempted within a duration predicted to transmit a preamble.

Also, the sensor network according to an embodiment of the present invention may be utilized for a ubiquitous environment and thus may be applicable in various types of fields. Also, in the ubiquitous environment, each sensor node may reduce a power consumption and enhance a signal reception rate.

Also, according to an embodiment of the present invention, a sampling duration may be computed and be stored for each of a number of neighboring nodes. Therefore, a reception node may adaptively perform sampling using a sampling duration corresponding to a number of neighboring nodes without a separate computation process.

The above-described exemplary embodiments of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM disks and DVDs; magneto-optical media such as floptical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed to by the computer using an interpreter. The described hardware devices may be configured to act as one or more software modules in order to perform the operations of the above-described exemplary embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A sensor node for a preamble sampling, comprising:
a transceiver to verify a number of neighboring nodes positioned in a sensor network; and
a sampling unit to perform the preamble sampling using a sampling duration that is set based on the number of neighboring nodes.

2. The sensor node of claim 1, further comprising:
a storage unit to store the sampling duration mapped with the number of neighboring nodes,
wherein the sampling unit verifies, from the storage unit, the sampling duration mapped with the number of neighboring nodes to perform the preamble sampling.

3. The sensor node of claim 1, wherein the sampling unit adjusts the sampling duration based on traffic at the sensor network and a transmission success rate of a preamble.

4. The sensor node of claim 3, wherein when a state of the sensor network is less than a reference value, the sampling unit extends the set sampling duration.

5. An apparatus of computing a preamble interval, comprising:
a first computation unit to compute a probability that a transmission node fails in a channel obtainment, an average time used until the transmission node fails in the channel obtainment and thereby a preamble transmission is cancelled, and an average time used until the transmission node succeeds in the channel obtainment and thereby the preamble transmission succeeds; and
a second computation unit to compute an expectation value of the preamble interval based on the computed two average times and a success probability of the channel obtainment according to a number of neighboring nodes.

6. The apparatus of claim 5, further comprising:
a third computation unit to compute a failure probability of a Clear Channel Assessment (CCA) based on the computed expectation value of the preamble interval, the number of neighboring nodes, and a length of a preamble signal; and
a controller to set the computed expectation value of the preamble interval as a sampling duration when the computed failure probability converges to a particular value.

7. The apparatus of claim 6, wherein the failure probability of the CCA is in proportion to the number of neighboring nodes.

8. The apparatus of claim 6, wherein the controller controls the first computation unit through the third computation unit to compute the expectation value of the preamble interval until the failure probability computed by the third computation unit converges to the particular value.

9. The apparatus of claim 5, wherein the expectation value of the preamble interval computed by the second computation unit is in proportion to the number of neighboring nodes.

10. The apparatus of claim 6, wherein the controller sets, as a sampling duration of a reception node, a value greater than or equal to the computed expectation value of the preamble interval.

11. A preamble sampling method of a sensor node, the method comprising:
verifying a number of neighboring nodes positioned in a sensor network; and
performing preamble sampling using a sampling duration that is set based on the number of neighboring nodes.

12. The method of claim 11, further comprising:
storing the sampling duration mapped with the number of neighboring nodes,
wherein the performing of the preamble sampling comprises verifying the sampling duration mapped with the number of neighboring nodes to perform the preamble sampling.

13. The method of claim 11, wherein the performing of the preamble sampling comprises adjusting the sampling duration based on traffic at the sensor network and a transmission success rate of a preamble.

14. The method of claim 13, wherein the performing of the preamble sampling comprises extending the set sampling duration when a state of the sensor network is less than a reference value.

15. A method of computing a preamble interval, comprising:
computing an average time used until a transmission node fails in a channel obtainment and thereby a preamble transmission is cancelled, and an average time used until the transmission node succeeds in the channel obtainment and the preamble transmission succeeds, based on a probability that the transmission node fails in the channel obtainment; and
computing an expectation value of the preamble interval based on the computed two average times and a success probability of the channel obtainment according to a number of neighboring nodes.

16. The method of claim 15, further comprising:
computing a failure probability of a CCA based on the computed expectation value of the preamble interval, the number of neighboring nodes, and a length of a preamble signal; and
setting the computed expectation value of the preamble interval as the sampling duration when the computed failure probability converges to a particular value.

17. The method of claim 16, wherein the failure probability of the CCA is in proportion to the number of neighboring nodes.

18. The method of claim 15, wherein the computed expectation value of the preamble interval is in proportion to the number of neighboring nodes.

19. The method of claim 16, wherein the setting comprises setting, as a sampling duration of a reception node, a value greater than or equal to the computed expectation value of the preamble interval.
